(19) United States
(12) Patent Application Publication
(10) Pub. No.: US 2020/0271973 A1
(43) Pub. Date: Aug. 27, 2020

(54) Holographic Polymer Dispersed Liquid Crystal Mixtures with High Diffraction Efficiency and Low Haze

(71) Applicant: DigiLens Inc., Sunnyvale, CA (US)

(72) Inventors: Jonathan David Waldern, Los Altos Hills, CA (US); Shibu Abraham, Sunnyvale, CA (US)

(73) Assignee: DigiLens Inc., Sunnyvale, CA (US)

(21) Appl. No.: 16/799,735

(22) Filed: Feb. 24, 2020

Related U.S. Application Data
(60) Provisional application No. 62/808,970, filed on Feb. 22, 2019.

(51) Int. Cl. G02F 1/1334; G03H 1/02

(52) U.S. Cl. CPC G02F 1/13342; G03H 2260/33; G03H 2260/12; G03H 1/024

(57) ABSTRACT

Holographic polymer dispersed liquid crystal material systems in accordance with various embodiments of the invention are illustrated. One embodiment includes a holographic polymer dispersed liquid crystal formulation, including monomers, photoinitiators, and a liquid crystal mixture including terphenyl compounds and non-terphenyl compounds, the liquid crystal mixture having a ratio of at least 1:10 by weight percentage of the terphenyl compounds to the non-terphenyl compounds, wherein the photoinitiators are configured to facilitate a photopolymerization induced phase separation process of the monomers and the liquid crystal mixture. In another embodiment, the liquid crystal mixture further includes pyrimidine compounds, and wherein the liquid crystal mixture has a ratio of at least 1:10 by weight percentage of the terphenyl compounds and pyrimidine compounds to the non-terphenyl compounds. In a further embodiment, the ratio of the terphenyl compounds to the non-terphenyl compounds is at least 1.5:10.

### CROSS-REFERENCE TO RELATED APPLICATIONS

The current application claims the benefit of and priority under 35 U.S.C. § 119(e) to U.S. Provisional Patent Application No. 62/808,970 entitled “Holographic Polymer Dispersed Liquid Crystal Mixtures with High Diffraction Efficiency and Low Haze,” filed Feb. 22, 2019. The disclosure of U.S. Provisional Patent Application No. 62/808,970 is hereby incorporated by reference in its entirety for all purposes.

### FIELD OF THE INVENTION

The present invention generally relates to holographic polymer dispersed liquid crystal materials and, more specifically, to holographic polymer dispersed liquid crystal materials with high diffraction efficiency and low haze.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE INVENTION

Holographic polymer dispersed liquid crystal material systems in accordance with various embodiments of the invention are illustrated. One embodiment includes a holographic polymer dispersed liquid crystal formulation, including monomers, photoinitiators, and a liquid crystal mixture including terphenyl compounds and non-terphenyl compounds, the liquid crystal mixture having a ratio of at least 1:10 by weight percentage of the terphenyl compounds to the non-terphenyl compounds, wherein the photoinitiators are configured to facilitate a photopolymerization induced phase separation process of the monomers and the liquid crystal mixture.

In another embodiment, the liquid crystal mixture further includes pyrimidine compounds, and wherein the liquid crystal mixture has a ratio of at least 1:10 by weight percentage of the terphenyl compounds and pyrimidine compounds to the non-terphenyl compounds.

In a further embodiment, the ratio of the terphenyl compounds to the non-terphenyl compounds is at least 1.5:10.

In still another embodiment, the ratio of the terphenyl compounds to the non-terphenyl compounds is at least 1:5.

In a still further embodiment, the terphenyl compounds include at least one of fluoro-terphenyl compounds, cyano-terphenyl compounds, and alkyl, alkoxy, thiocyanate, and isothiocyanate substituents thereof.

In yet another embodiment, the non-terphenyl compounds include at least one of cyanobiphenyl compounds, phenyl ester compounds, cyclohexyl compounds, and biphenyl ester compounds.

In a yet further embodiment, the formulation further includes at least one of nanoparticles, low-functionality monomers, additives for reducing switching voltage, additives for reducing switching time, additives for increasing refractive index modulation, and additives for reducing haze.

Another additional embodiment includes a holographic polymer dispersed liquid crystal formulation, including monomers, photoinitiators, and a liquid crystal mixture including higher-index liquid crystal compounds having an ordinary refractive index at 550 nm and at 25 degrees Celsius of 1.7 or more and other liquid crystal compounds having an ordinary refractive index at 550 nm and at 25 degrees Celsius of less than 1.7, the liquid crystal mixture having a ratio of at least 1:10 by weight percentage of the higher-index liquid crystal compounds to the other liquid crystal compounds, wherein the photoinitiators is configured to facilitate a photopolymerization induced phase separation process of the monomers and the liquid crystal mixture.

In a further additional embodiment, the ratio of the higher-index liquid crystal compounds to the other liquid crystal compounds is at least 1.5:10.

In another embodiment again, the ratio of the higher-index liquid crystal compounds to the other liquid crystal compounds is at least 1:5.

In a further embodiment again, the higher-index liquid crystal compounds include at least one of substituted terphenyl compounds, substituted pyrimidine compounds, substituted tolane compounds, and alkyl, alkoxy, thiocyanate, and isothiocyanate substituents thereof.

In still yet another embodiment, the other liquid crystal compounds include at least one of biphenyl compounds, cyanobiphenyl compounds, phenyl ester compounds, and biphenyl ester compounds.

In a still yet further embodiment, the formulation further includes at least one of nanoparticles, low-functionality monomers, additives for reducing switching voltage, additives for reducing switching time, additives for increasing refractive index modulation, and additives for reducing haze.

A still another additional embodiment includes a method for forming a holographic optical element, the method including providing a first transparent substrate, depositing a layer of optical recording material onto the first substrate, wherein the layer of optical recording material includes a liquid crystal mixture including terphenyl compounds and non-terphenyl compounds, the liquid crystal mixture having a ratio of at least 1:10 by weight percentage of the terphenyl compounds to the non-terphenyl compounds, placing a second transparent substrate onto the deposited layer of optical recording material, exposing the layer of optical recording material using at least one recording beam, and forming a waveguide having at least one grating structure within the layer of optical recording material.

In a still further additional embodiment, the ratio of the terphenyl compounds to the non-terphenyl compounds is at least 1.5:10.

In still another embodiment again, the ratio of the terphenyl compounds to the non-terphenyl compounds is at least 1:5.

In a still further embodiment again, the terphenyl compounds include at least one of fluoro, cyano, thiocyanate, and isothiocyanate substituted phenyl compounds.

In yet another additional embodiment, the non-terphenyl compounds include at least one of cyanobiphenyl compounds, phenyl ester compounds, and biphenyl ester compounds.

In a yet further additional embodiment, the layer of optical recording material further includes at least one of nanoparticles, low-functionality monomers, additives for reducing switching voltage, additives for reducing switching time, additives for increasing refractive index modulation, and additives for reducing haze.

In yet another embodiment again, the terphenyl compounds have an ordinary refractive index at 550 nm and at 25 degrees Celsius of 1.7 or more, and the non-terphenyl compounds have an ordinary refractive index at 550 nm and at 25 degrees Celsius of less than 1.7.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIGS. 1A and 1B conceptually illustrate HPDLC SBG devices and the switching property of SBGs in accordance with various embodiments of the invention.

FIGS. 2 and 3 conceptually illustrate molecular structure drawings for general compounds suitable for use in an LC mixture in accordance with various embodiments of the invention.

FIGS. 4 and 5 conceptually illustrate molecular structure drawings for general compounds suitable for use as dopants in an LC mixture in accordance with various embodiments of the invention.

FIG. 6 conceptually illustrates an example of a liquid crystal mixture containing four compounds in accordance with various embodiments of the invention.

FIG. 7 conceptually illustrates a molecular drawing of a fluorinated terphenyl utilized as a dopant in an HPDLC mixture in accordance with various embodiments of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

Holographic polymer dispersed liquid crystal materials and formulations in accordance with various embodiments of the invention can be devised to exhibit various characteristics and qualities. In many embodiments, HPDLC materials are implemented as optical recording materials for forming optical structures, such as but not limited to diffraction gratings. In some embodiments, the HPDLC materials are formulated and implemented to provide high diffraction efficiency (DE) and low haze. In typical HPDLC materials, efficient phase separation of monomers and liquid crystal (LC) during the recording process underlies both attributes. The diffraction efficiency can depend on the refractive index modulation achieved in a grating, which in turn can depend on various factors influencing morphology and phase separation, such as but not limited to: exposure beam intensity, temperature, LC concentration, molecular mass, chemical compatibility of the HPDLC components, molecular functionality, etc. Such factors can determine the degree of cross linking on the polymer matrix and, hence, the degree of phase separation between the monomer and LC components. If the phase separation and morphology are not adequate, the grating can result in low DE. Additionally, inadequate phase separation and morphology can result in the formation of large LC droplets or incomplete diffusion of LC, which can produce scatter and, consequently, haze.

The average index and index modulation requirements can vary depending on the specific requirements of a given application, such as but not limited to achieving a desired field of view of a waveguide display application. In many embodiments, a high refractive index LC of at least ˜1.7-1.8 is utilized to meet certain waveguide field of view requirements. Common LCs typically have low refractive index modulations. Increasing the index modulation can result in poor stability (such as but not limited to light/heat degradation) with bulky molecules and reduced chemical compatibility. Many available commercial LCs tend to be designed for switching applications. Oftentimes, such LCs can be suboptimal for many other display waveguides applications, including but not limited to those implementing passive gratings (or gratings intended to be operated passively).

Many embodiments of the invention are directed towards HPDLC systems for holographic waveguides implementing passive and/or switchable gratings using high index LC mixtures that can provide high diffraction efficiency and low haze. In some embodiments, the material system includes at least one high-index mesogenic dopant. In a number of embodiments, the material system includes terphenyls, stable tolanes, and/or nano-particles to achieve high-index LC cores. Terphenyls or tolanes can be utilized as high index or modulation dopants to increase DE generally and, more specifically, to enable the tailoring of index and index modulation for specific applications. In various embodiments, terphenyls, stable tolanes, and/or nano-particles can be added in proportions that result in improved DE with no appreciable increase in haze. In further embodiments, the material system is compatible with deposition or printing processes, such as but not limited to inkjet printing. Material systems compatible with such processes can allow for higher throughput manufacturing of waveguides and for the spatial modulation of specific material components within waveguides. Grating architectures, material modulation, and HPDLC material systems in accordance with various embodiments of the invention are discussed in the sections below in further detail.

### Optical Waveguide and Grating Structures

Optical structures recorded in waveguides can include many different types of optical elements, such as but not limited to diffraction gratings. Gratings can be implemented to perform various optical functions, including but not limited to coupling light, directing light, and preventing the transmission of light. In many embodiments, the gratings are surface relief gratings that reside on the outer surface of the waveguide. In other embodiments, the grating implemented is a Bragg grating (also referred to as a volume grating), which are structures having a periodic refractive index modulation. Bragg gratings can be fabricated using a variety of different methods. One process includes interferential exposure of holographic photopolymer materials to form periodic structures. Bragg gratings can have high efficiency with little light being diffracted into higher orders. The relative amount of light in the diffracted and zero order can be varied by controlling the refractive index modulation of the grating, a property that can be used to make lossy waveguide gratings for extracting light over a large pupil.

One class of Bragg gratings used in holographic waveguide devices is the Switchable Bragg Grating (SBG). SBGs can be fabricated by first placing a thin film of a mixture of photopolymerizable monomers and liquid crystal material between substrates. The substrates can be made of various types of materials, such glass and plastics. In many cases, the substrates are in a parallel configuration. In other embodiments, the substrates form a wedge shape. One or both substrates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize, and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (ITO). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 μs with a longer relaxation time to switch ON. The diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The substrates used to form the HPDLC cell provide a total internal reflection (TIR) light guiding structure. Light can be coupled out of the SBG when the switchable grating diffracts the light at an angle beyond the TIR condition. In a number of embodiments, a reverse mode grating device can be implemented—i.e., the grating is in its non-diffracting (cleared) state when the applied voltage is zero and switches to its diffracting stated when a voltage is applied across the electrodes.

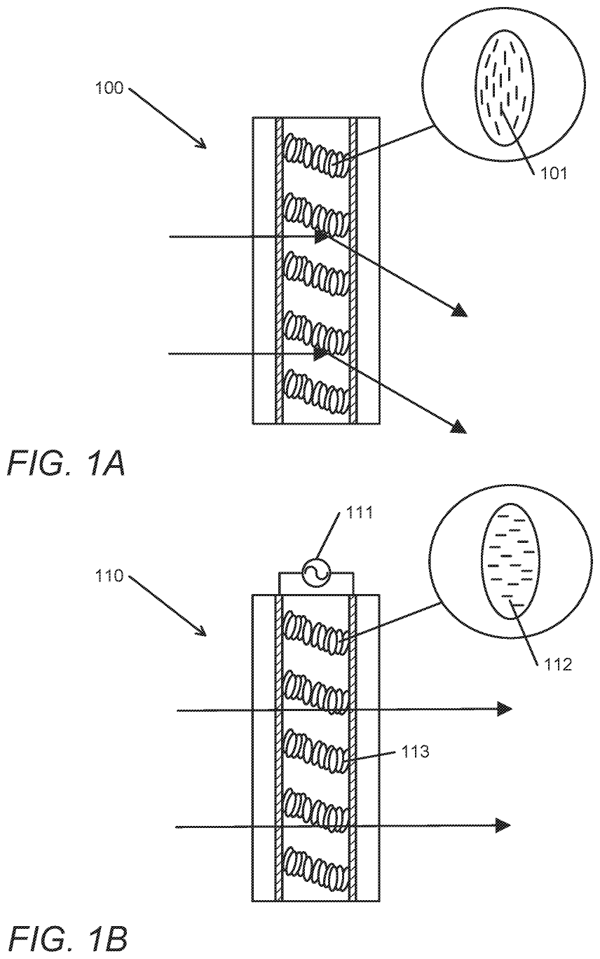

FIGS. 1A and 1B conceptually illustrate HPDLC SBG devices 100, 110 and the switching property of SBGs in accordance with various embodiments of the invention. In FIG. 1A, the SBG 100 is in an OFF state. As shown, the LC molecules 101 are aligned substantially normal to the fringe planes. As such, the SBG 100 exhibits high diffraction efficiency, and incident light can easily be diffracted. FIG. 1B illustrates the SBG 110 in an ON position. An applied voltage 111 can orient the optical axis of the LC molecules 112 within the droplets 113 to produce an effective refractive index that matches the polymer's refractive index, essentially creating a transparent cell where incident light is not diffracted. In the illustrative embodiment, an AC voltage source is shown. As can readily be appreciated, various voltage sources can be utilized depending on the specific requirements of a given application. Furthermore, different materials and device configurations can also be implemented. In some embodiments, the device implements different material systems and can operate in reverse with respect to the applied voltage—.e., the device exhibits high diffraction efficiency in response to an applied voltage.

In some embodiments, LC can be extracted or evacuated from the SBG to provide a surface relief grating (SRG) that has properties very similar to a Bragg grating due to the depth of the SRG structure (which is much greater than that practically achievable using surface etching and other conventional processes commonly used to fabricate SRGs). The LC can be extracted using a variety of different methods, including but not limited to flushing with isopropyl alcohol and solvents. In many embodiments, one of the transparent substrates of the SBG is removed, and the LC is extracted. In further embodiments, the removed substrate is replaced. The SRG can be at least partially backfilled with a material of higher or lower refractive index. Such gratings offer scope for tailoring the efficiency, angular/spectral response, polarization, and other properties to suit various waveguide applications.

Waveguides in accordance with various embodiments of the invention can include various grating configurations designed for specific purposes and functions. In many embodiments, the waveguide is designed to implement a grating configuration capable of preserving eyebox size while reducing lens size by effectively expanding the exit pupil of a collimating optical system. The exit pupil can be defined as a virtual aperture where only the light rays which pass though this virtual aperture can enter the eyes of a user. In some embodiments, the waveguide includes an input grating optically coupled to a light source, a fold grating for providing a first direction beam expansion, and an output grating for providing beam expansion in a second direction, which is typically orthogonal to the first direction, and beam extraction towards the eyebox. As can readily be appreciated, the grating configuration implemented waveguide architectures can depend on the specific requirements of a given application. In some embodiments, the grating configuration includes multiple fold gratings. In several embodiments, the grating configuration includes an input grating and a second grating for performing beam expansion and beam extraction simultaneously. The second grating can include gratings of different prescriptions, for propagating different portions of the field-of-view, arranged in separate overlapping grating layers or multiplexed in a single grating layer. Furthermore, various types of gratings and waveguide architectures can also be utilized.

In several embodiments, the gratings within each layer are designed to have different spectral and/or angular responses. For example, in many embodiments, different gratings across different grating layers are overlapped, or multiplexed, to provide an increase in spectral bandwidth. In some embodiments, a full color waveguide is implemented using three grating layers, each designed to operate in a different spectral band (red, green, and blue). In other embodiments, a full color waveguide is implemented using two grating layers, a red-green grating layer and a green-blue grating layer. As can readily be appreciated, such techniques can be implemented similarly for increasing angular bandwidth operation of the waveguide. In addition to the multiplexing of gratings across different grating layers, multiple gratings can be multiplexed within a single grating layer—i.e., multiple gratings can be superimposed within the same volume. In several embodiments, the waveguide includes at least one grating layer having two or more grating prescriptions multiplexed in the same volume. In further embodiments, the waveguide includes two grating layers, each layer having two grating prescriptions multiplexed in the same volume. Multiplexing two or more grating prescriptions within the same volume can be achieved using various fabrication techniques. In a number of embodiments, a multiplexed master grating is utilized with an exposure configuration to form a multiplexed grating. In many embodiments, a multiplexed grating is fabricated by sequentially exposing an optical recording material layer with two or more configurations of exposure light, where each configuration is designed to form a grating prescription. In some embodiments, a multiplexed grating is fabricated by exposing an optical recording material layer by alternating between or among two or more configurations of exposure light, where each configuration is designed to form a grating prescription. As can readily be appreciated, various techniques, including those well known in the art, can be used as appropriate to fabricate multiplexed gratings.

In many embodiments, the waveguide can incorporate at least one of: angle multiplexed gratings, color multiplexed gratings, fold gratings, dual interaction gratings, rolled K-vector gratings, crossed fold gratings, tessellated gratings, chirped gratings, gratings with spatially varying refractive index modulation, gratings having spatially varying grating thickness, gratings having spatially varying average refractive index, gratings with spatially varying refractive index modulation tensors, and gratings having spatially varying average refractive index tensors. In some embodiments, the waveguide can incorporate at least one of: a half wave plate, a quarter wave plate, an anti-reflection coating, a beam splitting layer, an alignment layer, a photochromic back layer for glare reduction, and louvre films for glare reduction. In several embodiments, the waveguide can support gratings providing separate optical paths for different polarizations. In various embodiments, the waveguide can support gratings providing separate optical paths for different spectral bandwidths. In a number of embodiments, the gratings can be HPDLC gratings, switching gratings recorded in HPDLC (such switchable Bragg Gratings), Bragg gratings recorded in holographic photopolymer, or surface relief gratings. In many embodiments, the waveguide operates in a monochrome band. In some embodiments, the waveguide operates in the green band. In several embodiments, waveguide layers operating in different spectral bands such as red, green, and blue (RGB) can be stacked to provide a three-layer waveguiding structure. In further embodiments, the layers are stacked with air gaps between the waveguide layers. In various embodiments, the waveguide layers operate in broader bands such as blue-green and green-red to provide two-waveguide layer solutions. In other embodiments, the gratings are color multiplexed to reduce the number of grating layers. Various types of gratings can be implemented. In some embodiments, at least one grating in each layer is a switchable grating.

Waveguides incorporating optical structures such as those discussed above can be implemented in a variety of different applications, including but not limited to waveguide displays. In various embodiments, the waveguide display is implemented with an eyebox of greater than 10 mm with an eye relief greater than 25 mm. In some embodiments, the waveguide display includes a waveguide with a thickness between 2.0-5.0 mm. In many embodiments, the waveguide display can provide an image field-of-view of at least 50° diagonal. In further embodiments, the waveguide display can provide an image field-of-view of at least 70° diagonal. The waveguide display can employ many different types of picture generation units (PGUs). In several embodiments, the PGU can be a reflective or transmissive spatial light modulator such as a liquid crystal on Silicon (LCoS) panel or a micro electromechanical system (MEMS) panel. In a number of embodiments, the PGU can be an emissive device such as an organic light emitting diode (OLED) panel. In some embodiments, an OLED display can have a luminance greater than 4000 nits and a resolution of 4 k×4 k pixels. In several embodiments, the waveguide can have an optical efficiency greater than 10% such that a greater than 400 nit image luminance can be provided using an OLED display of luminance 4000 nits. Waveguides implementing P-diffracting gratings (i.e., gratings with high efficiency for P-polarized light) typically have a waveguide efficiency of 5%-6.2%. Since P-diffracting or S-diffracting gratings can waste half of the light from an unpolarized source such as an OLED panel, many embodiments are directed towards waveguides capable of providing both S-diffracting and P-diffracting gratings to allow for an increase in the efficiency of the waveguide by up to a factor of two. In some embodiments, the S-diffracting and P-diffracting gratings are implemented in separate overlapping grating layers. Alternatively, a single grating can, under certain conditions, provide high efficiency for both p-polarized and s-polarized light. In several embodiments, the waveguide includes Bragg-like gratings produced by extracting LC from HPDLC gratings, such as those described above, to enable high S and P diffraction efficiency over certain wavelength and angle ranges for suitably chosen values of grating thickness (typically, in the range 2-5 μm).

### Optical Recording Material Systems

HPDLC mixtures generally include LC, monomers, photoinitiator dyes, and coinitiators. The mixture (often referred to as syrup) frequently also includes a surfactant. For the purposes of describing the invention, a surfactant is defined as any chemical agent that lowers the surface tension of the total liquid mixture. The use of surfactants in PDLC mixtures is known and dates back to the earliest investigations of PDLCs. For example, a paper by R. L Sutherland et al., SPIE Vol. 2689, 158-169, 1996, the disclosure of which is incorporated herein by reference, describes a PDLC mixture including a monomer, photoinitiator, coinitiator, chain extender, and LCs to which a surfactant can be added. Surfactants are also mentioned in a paper by Natarajan et al, Journal of Nonlinear Optical Physics and Materials, Vol. 5 No. I 89-98, 1996, the disclosure of which is incorporated herein by reference. Furthermore, U.S. Pat. No. 7,018,563 by Sutherland; et al., discusses polymer-dispersed liquid crystal material for forming a polymer-dispersed liquid crystal optical element having: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990s. Many of these materials use acrylate monomers, including:
R. L. Sutherland et al., Chem. Mater. 5, 1533 (1993), the disclosure of which is incorporated herein by reference, describes the use of acrylate polymers and surfactants. Specifically, the recipe includes a crosslinking multifunctional acrylate monomer; a chain extender N-vinyl pyrrolidinone, LC E7, photo-initiator rose Bengal, and coinitiator N-phenyl glycine. Surfactant octanoic acid was added in certain variants.
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator.
Y. H. Cho, et al., Polymer International, 48, 1085-1090, 1999, the disclosure of which is incorporated herein by reference, discloses HPDLC recipes including acrylates.
Karasawa et al., Japanese Journal of Applied Physics, Vol. 36, 6388-6392, 1997, the disclosure of which is incorporated herein by reference, describes acrylates of various functional orders.
T. J. Bunning et al., Polymer Science: Part B: Polymer Physics, Vol. 35, 2825-2833, 1997, the disclosure of which is incorporated herein by reference, also describes multifunctional acrylate monomers.
G. S. Iannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.
   Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems can also be used.

### Modulation of Material Composition

High luminance and excellent color fidelity are important factors in AR waveguide displays. In each case, high uniformity across the FOV can be desired. However, the fundamental optics of waveguides can lead to non-uniformities due to gaps or overlaps of beams bouncing down the waveguide. Further non-uniformities may arise from imperfections in the gratings and non-planarity of the waveguide substrates. In SBGs, there can exist a further issue of polarization rotation by birefringent gratings. In applicable cases, the biggest challenge is usually the fold grating where there are millions of light paths resulting from multiple intersections of the beam with the grating fringes. Careful management of grating properties, particularly the refractive index modulation, can be utilized to overcome non-uniformity.

Out of the multitude of possible beam interactions (diffraction or zero order transmission), only a subset contributes to the signal presented at the eye box. By reverse tracing from the eyebox, fold regions contributing to a given field point can be pinpointed. The precise correction to the modulation that is needed to send more into the dark regions of the output illumination can then be calculated. Having brought the output illumination uniformity for one color back on target, the procedure can be repeated for other colors. Once the index modulation pattern has been established, the design can be exported to the deposition mechanism, with each target index modulation translating to a unique deposition setting for each spatial resolution cell on the substrate to be coated/deposited. The resolution of the deposition mechanism can depend on the technical limitations of the system utilized. In many embodiments, the spatial pattern can be implemented to 30 micrometers resolution with full repeatability.

Compared with waveguides utilizing surface relief gratings (SRGs), SBG waveguides implementing manufacturing techniques in accordance with various embodiments of the invention can allow for the grating design parameters that impact efficiency and uniformity, such as but not limited to refractive index modulation and grating thickness, to be adjusted dynamically during the deposition process without the need for a different master. With SRGs where modulation is controlled by etch depth, such schemes would not be practical as each variation of the grating would entail repeating the complex and expensive tooling process. Additionally, achieving the required etch depth precision and resist imaging complexity can be very difficult.

Deposition processes in accordance with various embodiments of the invention can provide for the adjustment of grating design parameters by controlling the type of material that is to be deposited. Various embodiments of the invention can be configured to deposit different materials, or different material compositions, in different areas on the substrate. For example, deposition processes can be configured to deposit HPDLC material onto an area of a substrate that is meant to be a grating region and to deposit monomer onto an area of the substrate that is meant to be a non-grating region. In several embodiments, the deposition process is configured to deposit a layer of optical recording material that varies spatially in component composition, allowing for the modulation of various aspects of the deposited material. The deposition of material with different compositions can be implemented in several different ways. In many embodiments, more than one deposition head can be utilized to deposit different materials and mixtures. Each deposition head can be coupled to a different material/mixture reservoir. Such implementations can be used for a variety of applications. For example, different materials can be deposited for grating and non-grating areas of a waveguide cell. In some embodiments, HPDLC material is deposited onto the grating regions while only monomer is deposited onto the non-grating regions. In several embodiments, the deposition mechanism can be configured to deposit mixtures with different component compositions.

In some embodiments, spraying nozzles can be implemented to deposit multiple types of materials onto a single substrate. In waveguide applications, the spraying nozzles can be used to deposit different materials for grating and non-grating areas of the waveguide. In many embodiments, the spraying mechanism is configured for printing gratings in which at least one the material composition, birefringence, and/or thickness can be controlled using a deposition apparatus having at least two selectable spray heads. In some embodiments, the manufacturing system provides an apparatus for depositing grating recording material optimized for the control of laser banding. In several embodiments, the manufacturing system provides an apparatus for depositing grating recording material optimized for the control of polarization non-uniformity. In several embodiments, the manufacturing system provides an apparatus for depositing grating recording material optimized for the control of polarization non-uniformity in association with an alignment control layer. In a number of embodiments, the deposition workcell can be configured for the deposition of additional layers such as beam splitting coatings and environmental protection layers. Inkjet print heads can also be implemented to print different materials in different regions of the substrate.

As discussed above, deposition processes can be configured to deposit optical recording material that varies spatially in component composition. Modulation of material composition can be implemented in many different ways. In a number of embodiments, an inkjet print head can be configured to modulate material composition by utilizing the various inkjet nozzles within the print head. By altering the composition on a “dot-by-dot” basis, the layer of optical recording material can be deposited such that it has a varying composition across the planar surface of the layer. Such a system can be implemented using a variety of apparatuses including but not limited to inkjet print heads. Similar to how color systems use a palette of only a few colors to produce a spectrum of millions of discrete color values, such as the CMYK system in printers or the additive RGB system in display applications, inkjet print heads in accordance with various embodiments of the invention can be configured to print optical recording materials with varying compositions using only a few reservoirs of different materials. Different types of inkjet print heads can have different precision levels and can print with different resolutions. In many embodiments, a 300 DPI (“dots per inch”) inkjet print head is utilized. Depending on the precision level, discretization of varying compositions of a given number of materials can be determined across a given area. For example, given two types of materials to be printed and an inkjet print head with a precision level of 300 DPI, there are 90,001 possible discrete values of composition ratios of the two types of materials across a square inch for a given volume of printed material if each dot location can contain either one of the two types of materials. In some embodiments, each dot location can contain either one of the two types of materials or both materials. In several embodiments, more than one inkjet print head is configured to print a layer of optical recording material with a spatially varying composition. Although the printing of dots in a two-material application is essentially a binary system, averaging the printed dots across an area can allow for discretization of a sliding scale of ratios of the two materials to be printed. For example, the amount of discrete levels of possible concentrations/ratios across a unit square is given by how many dot locations can be printed within the unit square. As such, there can be a range of different concentration combinations, ranging from 100% of the first material to 100% of the second material. As can readily be appreciated, the concepts are applicable to real units and can be determined by the precision level of the inkjet print head. Although specific examples of modulating the material composition of the printed layer are discussed, the concept of modulating material composition using inkjet print heads can be expanded to use more than two different material reservoirs and can vary in precision levels, which largely depends on the types of print heads used.

Varying the composition of the material printed can be advantageous for several reasons. For example, in many embodiments, varying the composition of the material during deposition can allow for the formation of a waveguide with gratings that have spatially varying diffraction efficiencies across different areas of the gratings. In embodiments utilizing HPDLC mixtures, this can be achieved by modulating the relative concentration of liquid crystals in the HPDLC mixture during the printing process, which creates compositions that can produce gratings with varying diffraction efficiencies when the material is exposed. In several embodiments, a first HPDLC mixture with a certain concentration of liquid crystals and a second HPDLC mixture that is liquid crystal-free are used as the printing palette in an inkjet print head for modulating the diffraction efficiencies of gratings that can be formed in the printed material. In such embodiments, discretization can be determined based on the precision of the inkjet print head. A discrete level can be given by the concentration/ratio of the materials printed across a certain area. In this example, the discrete levels range from no liquid crystal to the maximum concentration of liquid crystals in the first PDLC mixture.

The ability to vary the diffraction efficiency across a waveguide can be used for various purposes. A waveguide is typically designed to guide light internally by reflecting the light many times between the two planar surfaces of the waveguide. These multiple reflections can allow for the light path to interact with a grating multiple times. In many embodiments, a layer of material can be printed with varying composition of materials such that the gratings formed have spatially varying diffraction efficiencies to compensate for the loss of light during interactions with the gratings to allow for a uniform output intensity. For example, in some waveguide applications, an output grating is configured to provide exit pupil expansion in one direction while also coupling light out of the waveguide. The output grating can be designed such that when light within the waveguide interact with the grating, only a percentage of the light is refracted out of the waveguide. The remaining portion continues in the same light path, which remains within TIR and continues to be reflected within the waveguide. Upon a second interaction with the same output grating again, another portion of light is refracted out of the waveguide. During each refraction, the amount of light still traveling within the waveguide decreases by the amount refracted out of the waveguide. As such, the portions refracted at each interaction gradually decreases in terms of total intensity. By varying the diffraction efficiency of the grating such that it increases with propagation distance, the decrease in output intensity along each interaction can be compensated, allowing for a uniform output intensity.

Varying the diffraction efficiency can also be used to compensate for other attenuation of light within a waveguide. All objects have a degree of reflection and absorption. Light trapped in TIR within a waveguide are continually reflected between the two surfaces of the waveguide. Depending on the material that makes up the surfaces, portions of light can be absorbed by the material during each interaction. In many cases, this attenuation is small, but can be substantial across a large area where many reflections occur. In many embodiments, a waveguide cell can be printed with varying compositions such that the gratings formed from the optical recording material layer have varying diffraction efficiencies to compensate for the absorption of light from the substrates. Depending on the substrates, certain wavelengths can be more prone to absorption by the substrates. In a multi-layered waveguide design, each layer can be designed to couple in a certain range of wavelengths of light. Accordingly, the light coupled by these individual layers can be absorbed in different amounts by the substrates of the layers. For example, in a number of embodiments, the waveguide is made of a three-layered stack to implement a full color display, where each layer is designed for one of red, green, and blue. In such embodiments, gratings within each of the waveguide layers can be formed to have varying diffraction efficiencies to perform color balance optimization by compensating for color imbalance due to loss of transmission of certain wavelengths of light.

In addition to varying the liquid crystal concentration within the material in order to vary the diffraction efficiency, another technique includes varying the thickness of the waveguide cell. This can be accomplished through the use of spacers. In many embodiments, spacers are dispersed throughout the optical recording material for structural support during the construction of the waveguide cell. In some embodiments, different sizes of spacers are dispersed throughout the optical recording material. The spacers can be dispersed in ascending order of sizes across one direction of the layer of optical recording material. When the waveguide cell is constructed through lamination, the substrates sandwich the optical recording material and, with structural support from the varying sizes of spacers, create a wedge-shaped layer of optical recording material. spacers of varying sizes can be dispersed similar to the modulation process described above. Additionally, modulating spacer sizes can be combined with modulation of material compositions. In several embodiments, reservoirs of HPDLC materials each suspended with spacers of different sizes are used to print a layer of HPDLC material with spacers of varying sizes strategically dispersed to form a wedge-shaped waveguide cell. In a number of embodiments, spacer size modulation is combined with material composition modulation by providing a number of reservoirs equal to the product of the number of different sizes of spacers and the number of different materials used. For example, in one embodiment, the inkjet print head is configured to print varying concentrations of liquid crystal with two different spacer sizes. In such an embodiment, four reservoirs can be prepared: a liquid crystal-free mixture suspension with spacers of a first size, a liquid crystal-free mixture-suspension with spacers of a second size, a liquid crystal-rich mixture-suspension with spacers of a first size, and a liquid crystal-rich mixture-suspension with spacers of a second size. Further discussion regarding material modulation can be found in U.S. application Ser. No. 16/203,071 filed Nov. 18, 2018 entitled “Systems and Methods for Manufacturing Waveguide Cells.” The disclosure of U.S. application Ser. No. 16/203,491 is hereby incorporated by reference in its entirety for all purposes.

### High DE and Low Haze Material Systems

Many embodiments in accordance with the invention include an HPDLC material system for holographic waveguides that can provide high diffraction efficiency and low haze. In some embodiments, the material system includes an LC mixture, monomers, photoinitiator dyes, and coinitiators. The material system often also includes a surfactant. As can readily be appreciated, the types of material components utilized can depend on the specific requirements of a given application. For example, aromatic polymers are typically superior to other polymers for fine-tuning gratings to provide high index and high index modulation tailored to different fields of view. In several embodiments, the LC mixture contains components selected for their DE performance, haze performance, and/or refractive indices. In various embodiments, the material system can be formulated to be compatible with deposition/printing processes for forming waveguides, such as the processes and techniques disclosed in U.S. application Ser. No. 16/203,071. For example, material systems can be formulated to have well-suited viscosities for use in a printed capable of depositing the mixture onto a waveguide substrate. In a number of embodiments, the material system is formulated and utilized in waveguides having plastic. In several embodiments, the material system is formulated and utilized in waveguide having curved substrates.

In many embodiments, the material system includes terphenyls, stable tolanes, and/or nano-particles. Such components can be utilized to achieve high-index LC cores. The LC mixture can be formulated to have specific relative concentrations of certain compounds, which can affect various performance characteristics. In several embodiments, the LC mixture is formulated to contain a minimum predetermined ratio by weight percentage of terphenyl compounds to non-terphenyl compounds. In some embodiments, the material system is formulated such that the LC mixture contains terphenyl compounds and biphenyl compounds at a ratio of at least 1:10 by weight percentage. In further embodiments, the ratio of terphenyl compounds and biphenyl compounds is at least 1.5:10 by weight percentage. In even further embodiments, the ratio of terphenyl compounds and biphenyl compounds is at least 1:5. In some embodiments, the LC mixture is formulated to contain a minimum predetermined ratio by weight percentage of tolane compounds to non-tolane compounds. In a number of embodiments, the material system is formulated such that the LC mixture contains a minimum predetermined ratio of compounds having ordinary refractive indices of less than 1.7 at 550 nm and at 25° C. to compounds having ordinary refractive indices of greater than 1.7 at 550 nm and at 25° C. The minimum predetermined ratios can vary widely. In several embodiments, the minimum predetermined ratio ranges from 1:10 to 1:2. As can readily be appreciated, the minimum predetermined ratios can vary and can depend on various factors, including the types of compounds and the desired diffraction efficiency and/or haze performance. For example, various classes of terphenyl compounds and biphenyl compounds implemented in the LC mixture can dictate the appropriate predetermined ratio. In several embodiments, the LC mixture includes pyrimidine compounds. In some embodiments, the LC mixture includes cyanoterphenyl compounds and cyanobiphenyl compounds and is formulated to have at least a ratio of 1:5 by weight percentage of cyanoterphenyl compounds to cyanobiphenyl compounds. In many embodiments, the LC mixture contains at least a ration of 1:2 of tolane compounds to non-tolane compounds. In a number of embodiments, the formulation includes an additive that can provide various functions. For example, the formulation can include nanoparticles, low functionality monomers, additives for reducing switching voltage, additives for reducing switching time, additives for increasing refractive index modulation, and/or additives for reducing haze.

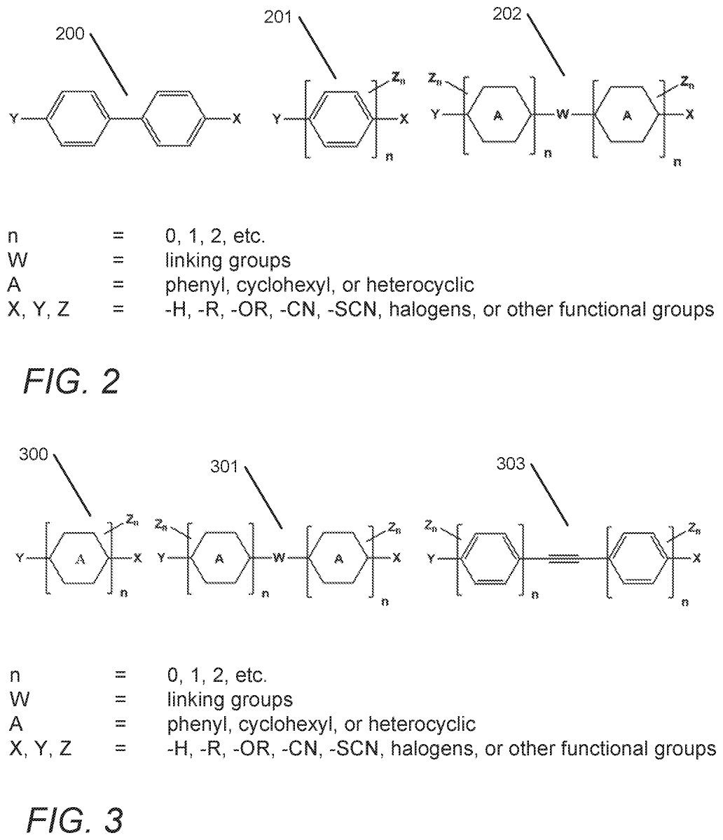

As described above, many different compounds can be utilized in LC mixtures in accordance with various embodiments of the invention. In many embodiments, the LC mixture can include various phenyl compounds, including but not limited to biphenyls and terphenyls. In some embodiments, various classes of biphenyls, pyrimidines, and terphenyls (including their derivatives—e.g., fluoro, cyano, alkyl, alkoxy, thiocyanate, and isothiocyanate substituents, and other functional groups) can be utilized as appropriate. For example, cyanobiphenyl compounds, phenyl ester compounds, cyclohexyl compounds, and biphenyl ester can be utilized. In several embodiments, the LC mixture includes compounds having alkyl-, alkoxy-, and other substituents. FIG. 2 conceptually illustrates molecular structure drawings for general compounds suitable for use in an LC mixture in accordance with various embodiments of the invention. As shown, LC mixtures in accordance with various embodiments of the invention can include biphenyls 200 and various other phenyl class compounds 201, including but not limited to terphenyls. In the illustrative embodiment, the LC mixture can also contain compounds 202 having cyclohexyl and heterocyclic groups. In addition to the phenyl compounds described above, LC mixtures utilized in accordance with various embodiments of the invention can include other classes of compounds, the specific choice of which can depend on the specific requirements of a given application. In several embodiments, an LC mixture containing tolane compounds is utilized in the material system. FIG. 3 conceptually illustrates molecular structure drawings for general compounds including tolanes suitable for use in an LC mixture in accordance with various embodiments of the invention. As shown, such LC mixtures can include general compounds 300,301 having various classes of chemical groups. In the illustrative embodiment, the LC mixture can also include different classes of tolane compounds 302. Although FIGS. 2 and 3 illustrate specific classes of compounds utilized in LC mixtures, any of a variety of different mixtures and compounds can be utilized as appropriate depending on the specific requirements of a given application.

In many embodiments, the material system includes at least one dopant, which can also be referred to as liquid crystal singles or liquid crystal monomers. In further embodiments, the material system includes at least one high-index mesogenic dopant. Terphenyls, tolanes, and/or nano-particles can be utilized as high index or modulation dopants to increase DE generally and more specifically to enable the index and index modulation to be tailored for specific applications. The concentration of various compounds within the material system can be controlled using such dopants to achieve a desired performance characteristic. For example, in several embodiments, the material system contains a concentration of dopants aimed to provide a desired diffraction efficiency and/or haze performance. The dopants and concentrations of dopants applied can depend on the types of compounds and their relative concentrations within the LC mixture. In some embodiments, the LC mixture can be doped with terphenyls, stable tolanes, and/or nano-particles in proportions that result in improved DE with no appreciable increase in haze (compared to the original LC mixture). For example, in a number of embodiments, the addition of approximately 5% of certain specific components can increase diffraction efficiency/performance by 20-30% with no appreciable increase in haze. In a number of embodiments, the LC mixture can be doped in proportions that result in a reduction of haze with no appreciable decrease in diffraction efficiency, relative to the undoped mixture. In some embodiments, the dopant concentrations are optimized to provide the specific index modulation and refractive index required for high efficiency for specific fields of view.

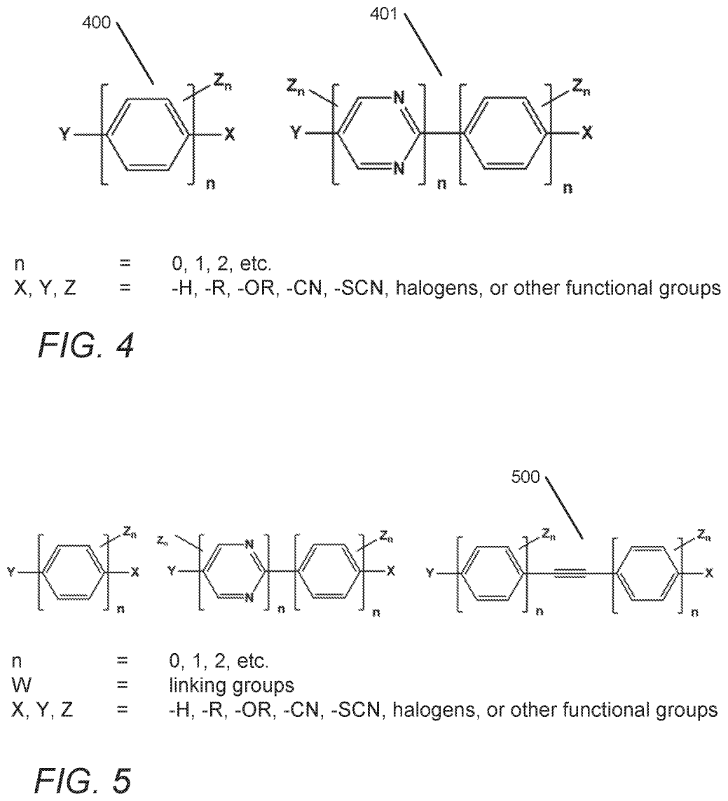

FIG. 4 conceptually illustrates molecular structure drawings for general compounds suitable for use as a dopant in an LC mixture in accordance with various embodiments of the invention. In the illustrative embodiment, the dopants include various classes of phenyl compounds 400 and various classes of pyrimidine compounds 401. Depending on the compounds in the LC mixture, an appropriate dopant can be utilized. For example, in some embodiments, the LC mixture include tolane compounds. In such cases, it can be more effective to use tolane compounds as dopants. FIG. 5 conceptually illustrates molecular structure drawings for general compounds including tolane compounds 500 suitable for use as a dopant in an LC mixture in accordance with various embodiments of the invention. Such compounds can be used as dopants for an LC mixture similar to the one illustrated in FIG. 3.

Although FIGS. 4 and 5 illustrate specific classes of compounds for use as dopants for LC mixtures in accordance with various embodiments of the invention, many other types of compounds can be utilized as appropriate depending on the specific requirements of a given application.

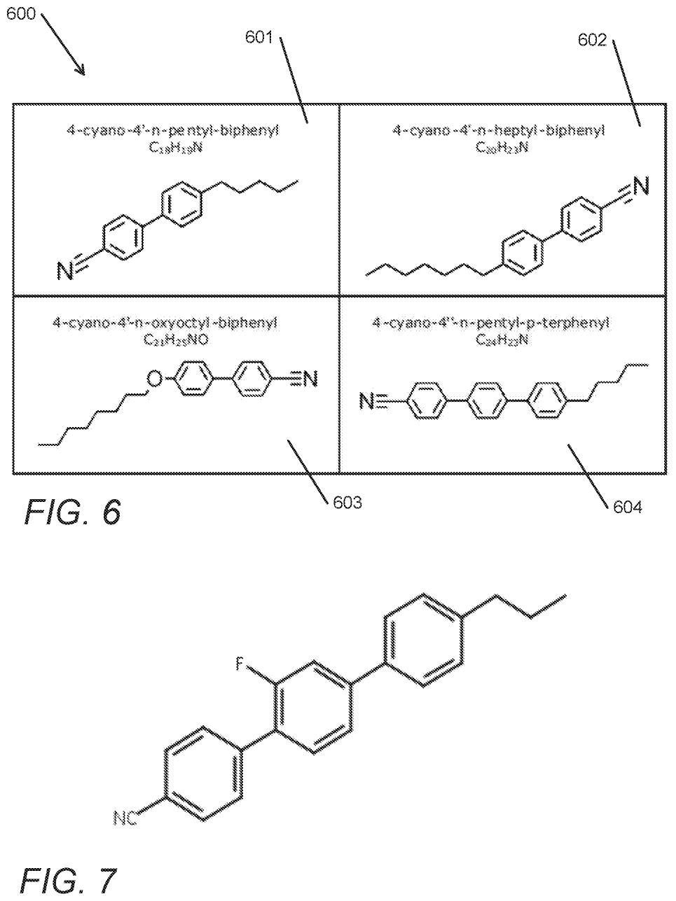

In many embodiments, the material system utilizes a commercially available LC mixture, which can be doped with certain components, such as but not limited to any of those described above, to provide certain component concentrations that can achieve a desired diffraction efficiency and/or haze performance. FIG. 6 provides an example of a liquid crystal mixture 600 containing four compounds. The first compound 601 is a cyanobiphenyl and is referred to as 5CB. Its concentration in LC mixture 600 is approximately 51%. For ease of clarity, concentration percentages describe the percent by weight of the component within the mixture. The second compound 602 is a cyanobiphenyl and is referred to as 7CB. Its concentration in LC mixture 600 is approximately 25%. The third compound 603 is a cyanobiphenyl and is referred to as 8OCB. Its concentration in LC mixture 600 is approximately 16%. The fourth compound 604 is a terphenyl and is referred to as 5CT. Its concentration in LC mixture 600 is approximately 8%. It is expected that the ordinary refractive indices of the cyanobiphenyl compounds 5CB, 7CB, and 8OCB will be less than 1.7 at 550 nm and at 25° C. On the other hand, it is expected that the ordinary refractive index of the terphenyl compound 5CT will be greater than 1.7 at 550 nm and at 25° C.

The LC mixture 600 can be mixed with monomers and photoinitiators to form a mixture of reactive monomers and liquid crystals, referred to as HPDLC precursor No. 1. In some embodiments, the HPDLC precursor No. 1 mixture is formulated to contain ˜42% of LC mixture 600 and ˜58% of monomers and photoinitiators. A holographic optical element formed from such mixtures can result in a diffraction efficiency of less than 10% diffraction efficiency and haze of less than 0.5%. In HPDLC precursor No. 1, the concentration of cyanobiphenyl compounds is 38.64%, and the concentration of cyanoterphenyl compounds is 3.36%, resulting in a ratio of cyanoterphenyl compounds to cyanobiphenyl compounds of approximately 0.087:1. Depending on the concentrations and ratios of terphenyl compounds and biphenyl compounds, the phase separation of the monomers and the liquid crystals can be affected accordingly, which can result in differences in diffraction efficiencies and haze. HPDLC precursor No. 1 can be doped with an additional component, such as but not limited to an additional liquid crystal compound. In many embodiments, the dopant(s) is introduced to change the ratio of concentrations of terphenyl compounds to biphenyl compounds to a desired level, which can provide desired changes in diffraction efficiencies and/or haze. In some embodiments, the ratio of terphenyl compounds to biphenyl compounds is altered to provide an increase in diffraction efficiency without an increase, or appreciable increase, in haze. For example, an improved HPDLC precursor No. 2 can be formed by mixing 95% of HPDLC precursor No. 1 with 5% of an additional liquid crystal compound, a fluorinated terphenyl. FIG. 7 conceptually illustrates a molecular drawing of a fluorinated terphenyl utilized as a dopant in an HPDLC mixture in accordance with various embodiments of the invention. In HPDLC precursor No. 2, the concentration of cyanobiphenyl compounds is 36.71%, and the concentration of cyanoterphenyl compounds is 8.19%, resulting in a ratio of cyanoterphenyl compounds to cyanobiphenyl compounds of approximately 0.223:1. Even though only 5% of the additional fluorinated terphenyl compound was added, the concentration of terphenyl compounds in the liquid crystal mixture increased significantly from the ratio in HPDLC precursor No. 1. A holographic optical element formed using HPDLC precursor No. 2 can result in a diffraction efficiency of greater than 30% and haze of less than 0.5%, demonstrating a considerable increase in diffraction efficiency without any appreciable increase in haze.

Although specific dopants are discussed above, any of a number of different types of dopants can be utilized according to the specific requirements of a given application. For example, many embodiments include the use of a quaterphenyl. In further embodiments, the quaterphenyl is twisted to maintain molecular conjugation. In other embodiments, a biphenyl is utilized as a dopant for the material system. As can readily be appreciated, any of a variety of different types of high-index mesogenic dopants appropriate to the requirements of a specific application can be utilized in material systems in accordance with various embodiments of the invention.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A holographic polymer dispersed liquid crystal formulation, comprising:
monomers;
photoinitiators; and
a liquid crystal mixture comprising terphenyl compounds and non-terphenyl compounds, said liquid crystal mixture having a ratio of at least 1:10 by weight percentage of said terphenyl compounds to said non-terphenyl compounds;
wherein said photoinitiators are configured to facilitate a photopolymerization induced phase separation process of said monomers and said liquid crystal mixture.

2. The holographic polymer dispersed liquid crystal formulation of claim 1, wherein said liquid crystal mixture further comprises pyrimidine compounds, and wherein said liquid crystal mixture has a ratio of at least 1:10 by weight percentage of said terphenyl compounds and pyrimidine compounds to said non-terphenyl compounds.

3. The holographic polymer dispersed liquid crystal formulation of claim 1, wherein said ratio of said terphenyl compounds to said non-terphenyl compounds is at least 1.5:10.

4. The holographic polymer dispersed liquid crystal formulation of claim 1, wherein said ratio of said terphenyl compounds to said non-terphenyl compounds is at least 1:5.

5. The holographic polymer dispersed liquid crystal formulation of claim 1, wherein said terphenyl compounds comprise a compound selected from the group consisting of:
fluoro-terphenyl compounds, cyano-terphenyl compounds, and alkyl, alkoxy, thiocyanate, and isothiocyanate substituents thereof.

6. The holographic polymer dispersed liquid crystal formulation of claim 1, wherein said non-terphenyl compounds comprise a compound selected from the group consisting of: cyanobiphenyl compounds, phenyl ester compounds, cyclohexyl compounds, and biphenyl ester compounds.

7. The holographic polymer dispersed liquid crystal formulation of claim 1, further comprising an additive selected from group consisting of: nanoparticles, low-functionality monomers, additives for reducing switching voltage, additives for reducing switching time, additives for increasing refractive index modulation, and additives for reducing haze.

8. A holographic polymer dispersed liquid crystal formulation, comprising:
monomers;
photoinitiators; and
a liquid crystal mixture comprising higher-index liquid crystal compounds having an ordinary refractive index at 550 nm and at 25 degrees Celsius of 1.7 or more and other liquid crystal compounds having an ordinary refractive index at 550 nm and at 25 degrees Celsius of less than 1.7, said liquid crystal mixture having a ratio of at least 1:10 by weight percentage of said higher-index liquid crystal compounds to said other liquid crystal compounds;
wherein said photoinitiators is configured to facilitate a photopolymerization induced phase separation process of said monomers and said liquid crystal mixture.

9. The holographic polymer dispersed liquid crystal formulation of claim 8, wherein said ratio of said higher-index liquid crystal compounds to said other liquid crystal compounds is at least 1.5:10.

10. The holographic polymer dispersed liquid crystal formulation of claim 8, wherein said ratio of said higher-index liquid crystal compounds to said other liquid crystal compounds is at least 1:5.

11. The holographic polymer dispersed liquid crystal formulation of claim 8, wherein said higher-index liquid crystal compounds comprise a compound selected from the group consisting of: substituted terphenyl compounds, substituted pyrimidine compounds, substituted tolane compounds, and alkyl, alkoxy, thiocyanate, and isothiocyanate substituents thereof.

12. The holographic polymer dispersed liquid crystal formulation of claim 8, wherein said other liquid crystal compounds comprise a compound selected from the group consisting of: biphenyl compounds, cyanobiphenyl compounds, phenyl ester compounds, and biphenyl ester compounds.

13. The holographic polymer dispersed liquid crystal formulation of claim 8, further comprising an additive selected from group consisting of: nanoparticles, low-functionality monomers, additives for reducing switching voltage, additives for reducing switching time, additives for increasing refractive index modulation, and additives for reducing haze.

14. A method for forming a holographic optical element, the method comprising:
providing a first transparent substrate;
depositing a layer of optical recording material onto said first substrate, wherein said layer of optical recording material comprises a liquid crystal mixture comprising terphenyl compounds and non-terphenyl compounds, said liquid crystal mixture having a ratio of at least 1:10 by weight percentage of said terphenyl compounds to said non-terphenyl compounds;
placing a second transparent substrate onto said deposited layer of optical recording material;
exposing said layer of optical recording material using at least one recording beam; and
forming a waveguide having at least one grating structure within said layer of optical recording material.

15. The method of claim 14, wherein said ratio of said terphenyl compounds to said non-terphenyl compounds is at least 1.5:10.

16. The method of claim 14, wherein said ratio of said terphenyl compounds to said non-terphenyl compounds is at least 1:5.

17. The method of claim 14, wherein said terphenyl compounds comprise a compound selected from the group consisting of: fluoro, cyano, thiocyanate, and isothiocyanate substituted phenyl compounds.

18. The method of claim 14, wherein said non-terphenyl compounds comprise a compound selected from the group consisting of: cyanobiphenyl compounds, phenyl ester compounds, and biphenyl ester compounds.

19. The method of claim 14, wherein said layer of optical recording material further comprises an additive selected from group consisting of: nanoparticles, low-functionality monomers, additives for reducing switching voltage, additives for reducing switching time, additives for increasing refractive index modulation, and additives for reducing haze.

20. The method of claim 14, wherein said terphenyl compounds have an ordinary refractive index at 550 nm and at 25 degrees Celsius of 1.7 or more; and said non-terphenyl compounds have an ordinary refractive index at 550 nm and at 25 degrees Celsius of less than 1.7.
